(19) United States
(12) Patent Application Publication
(10) Pub. No.: US 2006/0226799 A1
(43) Pub. Date: Oct. 12, 2006

(54) Motor unit including a controller that protects a motor of the motor unit from burnout

(76) Inventors: Chi-Chung Lin, Chang-Hua Hsien (TW); Yung-Fa Chen, Tainan City (TW); Lung-Chieh Chen, Chang-Hua Hsien (TW)

Correspondence Address: TROP PRUNER & HU, PC, 1616 S. VOSS ROAD, SUITE 750, HOUSTON, TX, 77057-2631, US

(21) Appl. No.: 11/100,703

(22) Filed: Apr. 7, 2005

(51) Int. Cl. H02P 5/00

(52) U.S. Cl. 318/139; 318/434

(57) ABSTRACT

A motor unit includes a motor, a power source, and a motor control circuit. The power source supplies electric current to the motor. The motor control circuit is coupled to the motor and the power source, and includes a driver, a detector, and a controller. The driver controls duty cycle of the motor. The detector is coupled to the driver, and is operable so as to detect amount of the electric current supplied by the power source to the motor. The controller is coupled to the detector, and enables the driver to control operation of the motor at a reduced duty cycle reduced from an initial duty cycle when the amount of the electric current detected by the detector is higher than a predetermined reference threshold value configured in the controller. A method for protecting a motor from burnout is also disclosed.

### BACKGROUND OF THE INVENTION

1. Field of the Invention

The invention relates to a motor unit, more particularly to a motor unit that includes a controller that protects a motor of the motor unit from burnout.

2. Description of the Related Art

FIG. 1 illustrates a conventional motor unit that includes a battery 91, a motor 92, a driver, and a fuse 93. The battery 91 is coupled to and supplies electric current to the motor 92. The driver controls duty cycle of the motor 92, and includes a pulse-width modulator 95 coupled to the battery 91, and a switching transistor 94 coupled to the battery 91 and the pulse-width modulator 95 of the driver. The fuse 93 is coupled between the motor 92 and the switching transistor 94 of the driver. The fuse 93 protects the motor 92 from burnout by interrupting the supply of the electric current to the motor 92 when overloaded.

The aforesaid conventional motor unit is disadvantageous in that the excessive electric current may cause damage the motor 92 even before the fuse 93 has blown. Furthermore, the fuse 93 has to be replaced whenever an overload or a surge occurs.

### SUMMARY OF THE INVENTION

Therefore, the object of the present invention is to provide a motor unit that includes a controller capable of overcoming the aforesaid drawbacks of the prior art.

According to one aspect of the present invention, a motor unit comprises a motor, a power source, and a motor control circuit. The power source supplies electric current to the motor. The motor control circuit is coupled to the motor and the power source, and includes a driver, a detector, and a controller. The driver controls duty cycle of the motor. The detector is coupled to the driver, and is operable so as to detect amount of the electric current supplied by the power source to the motor. The controller is coupled to the detector, and enables the driver to control operation of the motor at a reduced duty cycle reduced from an initial duty cycle when the amount of the electric current detected by the detector is higher than a predetermined reference threshold value configured in the controller, thereby reducing the amount of the electric current supplied by the power source to the motor.

According to another aspect of the present invention, a motor control circuit is adapted to be coupled to a motor and a power source for supplying electric current to the motor, and comprises a driver, a detector, and a controller. The driver is adapted for duty cycle control of the motor. The detector is coupled to the driver, and is operable so as to detect amount of the electric current supplied by the power source to the motor. The controller is coupled to the detector, and enables the driver to control operation of the motor at a reduced duty cycle reduced from an initial duty cycle when the amount of the electric current detected by the detector is higher than a predetermined reference threshold value configured in the controller, thereby reducing the amount of the electric current supplied by the power source to the motor.

According to yet another aspect of the present invention, a method for protecting a motor from burnout comprises the steps of:

(A) controlling operation of the motor at an initial duty cycle;

(B) continuously detecting amount of electric current supplied by a power source to the motor;

(C) comparing the amount of the electric current detected in step (B) with a predetermined reference threshold value; and

(D) when the amount of the electric current detected in step (B) is found in step (C) to be higher than the predetermined reference threshold value, controlling operation of the motor at a reduced duty cycle reduced from an initial duty cycle, thereby reducing the amount of the electric current supplied by the power source to the motor.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic circuit block diagram of a conventional motor unit;

FIG. 2 is a schematic circuit block diagram of the first preferred embodiment of a motor unit according to the present invention;

FIGS. 3A and 3B is a flowchart of the preferred embodiment of a method for protecting a motor from burnout according to the present invention;

FIG. 4 is a schematic circuit block diagram of the second preferred embodiment of a motor unit according to the present invention;

FIG. 5 is a schematic circuit block diagram of the third preferred embodiment of a motor unit according to the present invention; and

FIG. 6 is a schematic circuit block diagram of the fourth preferred embodiment of a motor unit according to the present invention.

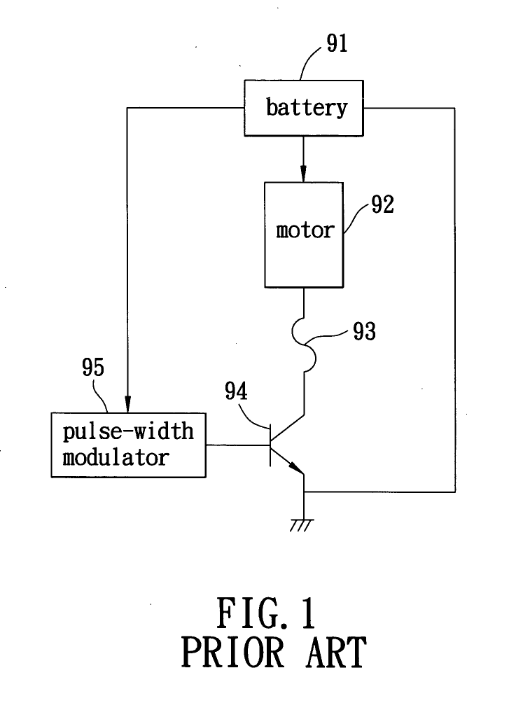

### DETAILED DESCRIPTION OF THE PREFERRED EMBODIMENTS

Before the present invention is described in greater detail, it should be noted that like elements are denoted by the same reference numerals throughout the disclosure.

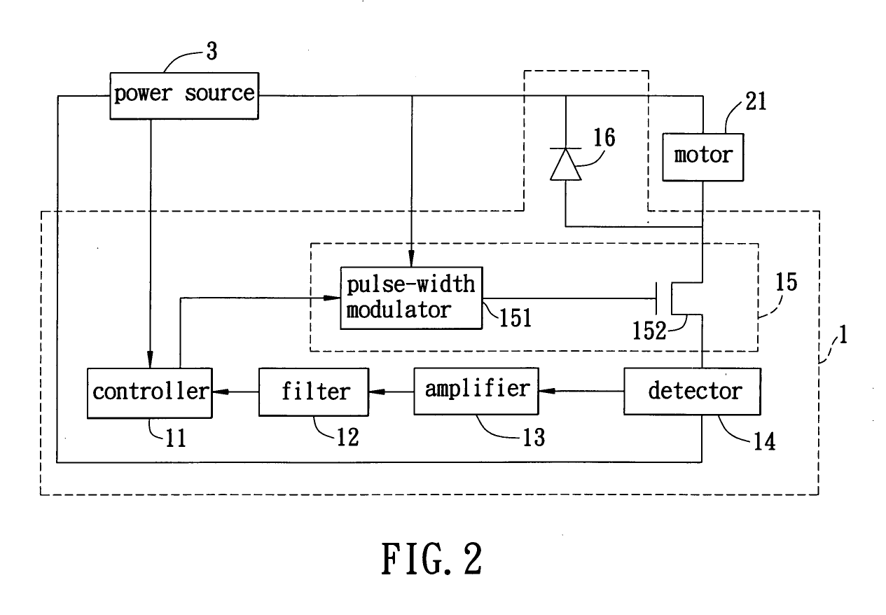

Referring to FIG. 2, the first preferred embodiment of a motor unit according to this invention is shown to include a motor 21, a power source 3, and a motor control circuit 1.

The power source 3 is coupled to and supplies electric current to the motor 21. In this embodiment, the power source 3 is a battery.

The motor control circuit 1 includes a driver 15, a detector 14, and a controller 11.

The driver 15 of the motor control circuit 1 includes a pulse-width modulator 151 that is coupled to the power source 3, and a switching transistor 152 that is coupled to the motor 21 and the pulse-width modulator 151 of the driver 15 of the motor control circuit 1.

The motor control circuit 1 further includes a freewheeling diode 16 that is coupled across the motor 21.

The detector 14 of the motor control circuit 1 is coupled between the power source 3 and the switching transistor 152 of the driver 15 of the motor control circuit 1. In this embodiment, the detector 14 of the motor control circuit 1 includes a resistor. In an alterative embodiment, the detector 14 of the motor control circuit 1 includes a Hall element. In yet another embodiment, the detector 14 of the motor control circuit 1 includes a device that converts the electric current supplied by the power source 3 to the motor 21 into a voltage signal.

The motor control circuit 1 further includes an amplifier 13 coupled to the detector 14 of the motor control circuit 1, and a filter 12 coupled to the amplifier 13 of the motor control circuit 1. In this embodiment, the filter 12 of the motor control circuit 1 is a low-pass filter.

The controller 11 of the motor control circuit 1 is coupled to the filter 12 of the motor control circuit 1, the pulse-width modulator 151 of the driver 15 of the motor control circuit 1, and the power source 3. The controller 11 of the motor control circuit 1 protects the motor 21 from burnout in a manner that will be described in greater detail hereinafter.

It is noted that the controller 11 of the motor control circuit 1 is configured with a plurality of predetermined reference threshold values, and a plurality of initial duty cycles.

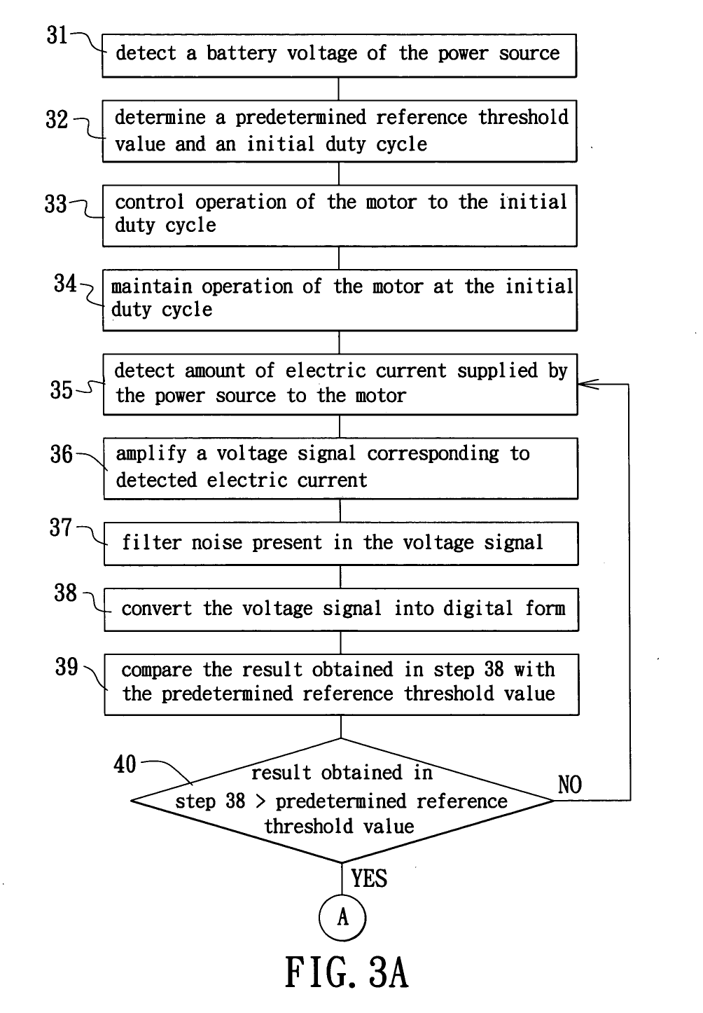

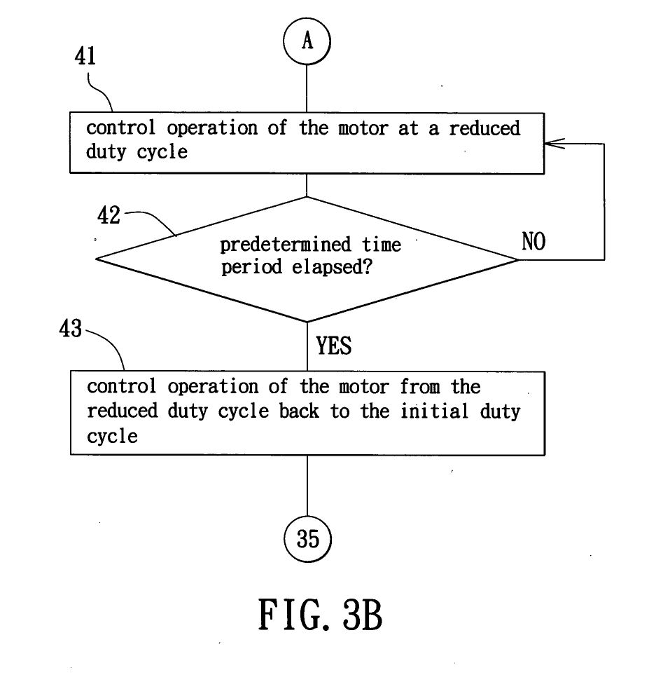

The preferred embodiment of the method for protecting the motor 21 from burnout according to this invention comprises the steps shown in FIGS. 3A and 3B.

In step 31, upon activation of the motor unit, the controller 11 of the motor control circuit 1 detects a battery voltage of the power source 3.

In step 32, the controller 11 of the motor control circuit 1 determines a predetermined reference threshold value and an initial duty cycle that are configured therein with reference to the battery voltage of the power source 3 and a preset motor wattage setting of the motor 21.

In step 33, the controller 11 of the motor control circuit 1 enables the driver 15 of the motor control circuit 1 to control operation of the motor 21 by gradually incrementing duty cycle of the motor 21 to the initial duty cycle determined in step 32. Thereafter, in step 34, the controller 11 of the motor control circuit 1 enables the driver 15 of the motor control circuit 1 to maintain operation of the motor 21 at the initial duty cycle.

In step 35, the controller 11 of the motor control circuit 1 detects amount of electric current supplied by the power source 3 to the motor 21.

In step 36, the amplifier 13 of the motor control circuit 1 amplifies a voltage signal from the detector 14 corresponding to the detected electric current.

In step 37, the filter 12 of the motor control circuit 1 filters noise present in the voltage signal amplified in step 36.

In step 38, the controller 11 of the motor control circuit 1 converts the voltage signal filtered in step 37 into a digital form.

In step 39, the controller 11 of the motor control circuit 1 compares the result obtained in step 38 with the predetermined reference threshold value determined in step 32.

In step 40, when the result obtained in step 38 is found in step 39 to be higher than the predetermined reference threshold value, this indicates that an overload has occurred, and the flow then proceeds to step 41. Otherwise, when the result obtained in step 38 is found in step 39 to be lower than the predetermined reference threshold value, this indicates that the motor 21 is operating normally, and the flow goes back to step 35.

In step 41, the controller 11 of the motor control circuit 1 controls operation of the motor 21 at a reduced duty cycle reduced from the initial duty cycle. As such, the amount of the electric current supplied by the power source 3 to the motor 21 is reduced, thereby protecting the motor 21 from burnout.

In step 42, after a predetermined time period has elapsed, the flow proceeds to step 43. Otherwise, the flow goes back step 41.

In step 43, the controller 11 of the motor control circuit 1 controls operation of the motor 21 from the reduced duty cycle back to the initial duty cycle. Thereafter, the flow goes back to step 35.

It is noted that, since the battery voltage of the power source 3 fluctuates during the operation of the motor unit, the controller 11 of the motor control circuit 1 enables the driver 151 to control operation of the motor 21 to a duty cycle in accordance with the fluctuation of the battery voltage of the power source 3 in order to regulate the electric current supplied by the power source 3 to the motor 21. As such, the fluctuation of the battery voltage of the power source 3 causes minimal effect to the operation of the motor unit. Moreover, the controller 11 of the motor control circuit 1 is able to accurately compare the electric current supplied by the power source 3 to the motor 21 with the predetermined reference threshold value.

It is also noted that, although the motor unit of this invention is exemplified using only a single motor 21, it should be apparent to those skilled in the art that the number of motors may be increased as required.

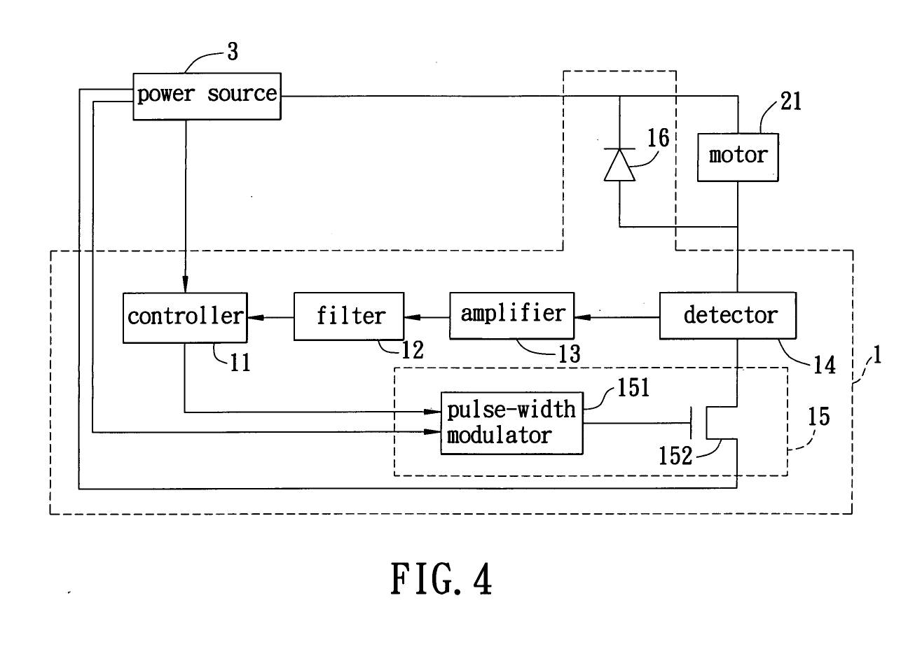

FIG. 4 illustrates the second preferred embodiment of a motor unit according to this invention. When compared to the previous embodiment, the detector 14 of the motor control circuit 1 is coupled to the motor 21. Moreover, the switching transistor 152 of the driver 15 of the motor control circuit 1 is coupled between the detector 14 of the motor control circuit 1 and the power source 3.

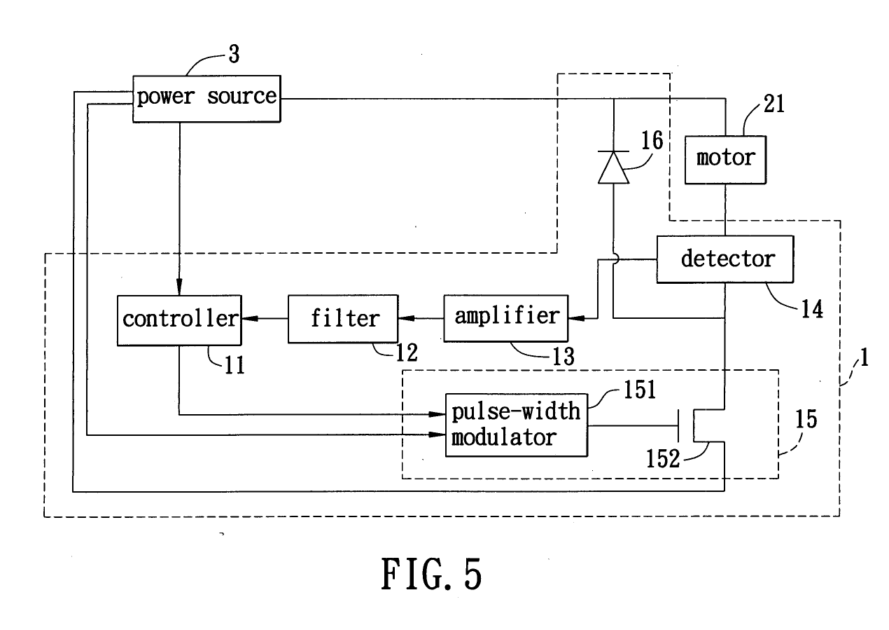

FIG. 5 illustrates the third preferred embodiment of a motor unit according to this invention. When compared to the second embodiment, the freewheeling diode 16 of the motor control circuit 1 is coupled across the series combination of the motor 21 and the detector 14 of the motor control circuit 1.

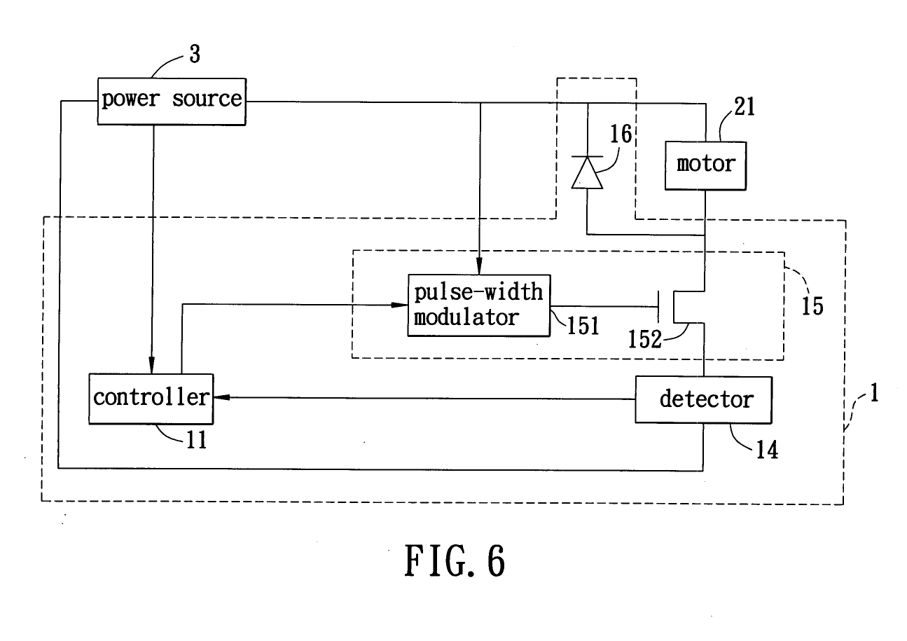

FIG. 6 illustrates the fourth preferred embodiment of a motor unit according to this invention. When compared to the first embodiment, the amplifier 13 (see FIG. 2) and the filter 12 (see FIG. 2) of the motor control circuit 1 are dispensed with in this embodiment.

It is noted that the motor control circuit 1 may be sold separately from the power source 3 and the motor 21, and may be applied to devices that include a power source and a motor.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A motor unit, comprising:
a motor;
a power source for supplying electric current to said motor; and
a motor control circuit coupled to said motor and said power source, and including
a driver for duty cycle control of said motor,
a detector coupled to said driver, and operable so as to detect amount of the electric current supplied by said power source to said motor, and
a controller coupled to said detector, and enabling said driver to control operation of said motor at a reduced duty cycle reduced from an initial duty cycle when the amount of the electric current detected by said detector is higher than a predetermined reference threshold value configured in said controller, thereby reducing the amount of the electric current supplied by said power source to said motor, and from the reduced duty cycle back to the initial duty cycle after a predetermined time period has elapsed.

2. (canceled)

3. The motor unit as claimed in claim 1, wherein said controller further enables said driver to control the duty cycle of said motor based on specifications of said motor and said power source.

4. The motor unit as claimed in claim 1, wherein said controller of said motor control circuit is configured with the reference threshold value based on specifications of said motor and said power source.

5. The motor unit as claimed in claim 1, wherein said motor control circuit further includes a filter coupled between said detector and said controller.

6. The motor unit as claimed in claim 5, wherein said filter is a low-pass filter.

7. The motor unit as claimed in claim 1, wherein said motor control circuit further includes an amplifier coupled between said detector and said controller.

8. The motor unit as claimed in claim 1, wherein said power source includes a battery.

9. The motor unit as claimed in claim 8, wherein said controller further enables said driver to control the duty cycle of said motor with reference to a battery voltage of said battery.

10. The motor unit as claimed in claim 1, wherein said driver of said motor controller circuit includes a pulse-width modulator.

11. The motor unit as claimed in claim 1, wherein said motor control circuit further includes a freewheeling diode coupled across said motor.

12. The motor unit as claimed in claim 1, wherein said detector includes a resistor.

13. A motor control circuit adapted to be coupled to a motor and a power source for supplying electric current to the motor, said motor control circuit comprising;
a driver adapted for duty cycle control of the motor;
a detector coupled to said driver, and operable so as to detect amount of the electric current supplied by the power source to the motor; and
a controller coupled to said detector, and enabling said driver to control operation of the motor at a reduced duty cycle reduced from an initial duty cycle when the amount of the electric current detected by said detector is higher than a predetermined reference threshold value configured in said controller, thereby reducing the amount of the electric current supplied by the power source to the motor, and from the reduced duty cycle back to the initial duty cycle after a predetermined time period has elapsed.

14. (canceled)

15. The motor control circuit as claimed in claim 13, wherein said controller further enables said driver to control the duty cycle of the motor based on specifications of the motor and the power source.

16. The motor control circuit as claimed in claim 13, wherein said controller is configured with the reference threshold value based on specifications of the motor and the power source.

17. The motor control circuit as claimed in claim 13, further comprising a filter coupled between said detector and said controller.

18. The motor control circuit as claimed in claim 17, wherein said filter is a low-pass filter.

19. The motor control circuit as claimed in claim 13, further comprising an amplifier coupled between said detector and said controller.

20. The motor control circuit as claimed in claim 13, wherein said driver includes a pulse-width modulator.

21. The motor control circuit as claimed in claim 13, further comprising a flywheel diode adapted to be coupled across the motor.

22. The motor control circuit as claimed in claim 13, wherein said detector includes a resistor.

23. A method for protecting a motor from burnout, comprising the steps of:
(A) controlling operation of the motor at an initial duty cycle;
(B) continuously detecting amount of electric current supplied by a power source to the motor;
(C) comparing the amount of the electric current detected in step (B) with a predetermined reference threshold value;
(D) when the amount of the electric current detected in step (B) is found in step (C) to be higher than the predetermined reference threshold value, controlling operation of the motor at a reduced duty cycle reduced from the initial duty cycle, thereby reducing the amount of the electric current supplied by the power source to the motor; and
(E) after a predetermined time period has elapsed, controlling operation of the motor from the reduced duty cycle back to the initial duty cycle.

24. (canceled)

25. The method as claimed claim 23, further comprising the step of converting the amount of the electric current detected in step (B) into a voltage.

26. The method as claimed in claim 25, further comprising the step of amplifying the voltage prior to step (C).

27. The method as claimed in claim 26, further comprising the step of filtering noise present in the voltage prior to step (C).
